(19) United States
(12) Patent Application Publication
(10) Pub. No.: US 2017/0343347 A1
(43) Pub. Date: Nov. 30, 2017

(54) EASY ASSEMBLY LEVEL

(71) Applicant: Ching Lin Plastic Industry Co., Ltd., Taichung City (TW)

(72) Inventor: Wen-Hsin Liao, Taichung City (TW)

(21) Appl. No.: 15/164,936

(22) Filed: May 26, 2016

(51) Int. Cl. G01C 9/34

(52) U.S. Cl. CPC G01C 9/34

(57) ABSTRACT

An easy assembly level includes a body, a fixing assembly, and a bubble level vial. The body defines a compartment. The fixing assembly includes a first retainer and a second retainer. The first and second retainers are releasably joinable to each other and are releasably mountable on the body. The first retainer defines a channel and the bubble level vial is received in the channel. The first retainer is inserted in the compartment and is mounted on the body. The second retainer is inserted in the compartment and is mounted on the body. The first and second retainers are releasably joined together and encapsulate the bubble level vial. The first retainer defines a first window and the second retainer defines a second window respectively.

### BACKGROUND OF THE INVENTION

### 1. Field of the Invention

The present invention relates to a level and, particularly, to an easy assembly level.

### 2. Description of the Related Art

TW Pat. No. M281167 shows a level including a body, a fixing assembly, and a bubble level vial. The bubble level vial is releasably fixed to the body by the fixing assembly. The fixing assembly includes a seat, two protective windows, and two retainers. The seat is disposed within the body and defines a space receiving the bubble level vial. The bubble level vial is secured to the seat by a plurality of fasteners. The two protective windows combine together and capsulate the bubble level vial. The two retainers respectively receive the two protective windows and are releasably engaged with the body.

The level is designed such that the bubble level vial can dismount from the level. However, the design of the level is complicated and it is not easy to assemble the level.

The present invention is, therefore, intended to obviate or at least alleviate the problems encountered in the prior art.

### SUMMARY OF THE INVENTION

According to the present invention, an easy assembly level includes a body, at least one fixing assembly, and at least one bubble level vial. The body defines at least one compartment. The at least one compartment extends through the body. The at least one compartment defines a first opening on a first side of the body and a second opening on a second side of the body respectively. The at least one fixing assembly includes a first retainer and a second retainer. The first and second retainers are releasably joinable to each other. The first and second retainers are releasably mountable on the body. The first retainer defines a channel and the at least one bubble level vial is received in the channel. The first retainer is inserted in the at least one compartment through the first opening and is releasably mounted on the body. The second retainer is inserted in the at least one compartment through the second opening and is relesably mounted on the body. The first and second retainers are releasably joined together and encapsulate the at least one bubble level vial. Thus, the at least one bubble level vial is restrained by the first and second retainers and is fixed to the body and is disposed inside the at least one compartment. The first retainer defines a first window and the second retainer defines a second window respectively. The at least one bubble level vial is visible from either the first window or the second window.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the public generally, and especially the scientists, engineers and practitioners in the art who are not familiar with patent or legal terms or phraseology, to determine quickly from a cursory inspection the nature and essence of the technical disclosure. The abstract is neither intended to define the invention, which is measured by the claims, nor is it intended to be limiting as to the scope of the invention in any way.

It is therefore an objective of the present invention to provide an easy assembly level.

It is another objective of the present invention that the level can be assembled without the aid of tools.

Other objectives, advantages, and new features of the present invention will become apparent from the following detailed description of the invention when considered in conjunction with the accompanied drawings.

### BRIEF DESCRIPTION OF THE DRAWINGS

FIG. 1 is a perspective view of an easy assembly level in accordance with the present invention.

FIG. 2 is an exploded perspective view of the easy assembly level of the present invention.

FIG. 3 is a cross-sectional view taken along line 3-3 of FIG. 1.

FIG. 4 is a cross-sectional view taken along line 4-4 of FIG. 1.

### DETAILED DESCRIPTION OF THE INVENTION

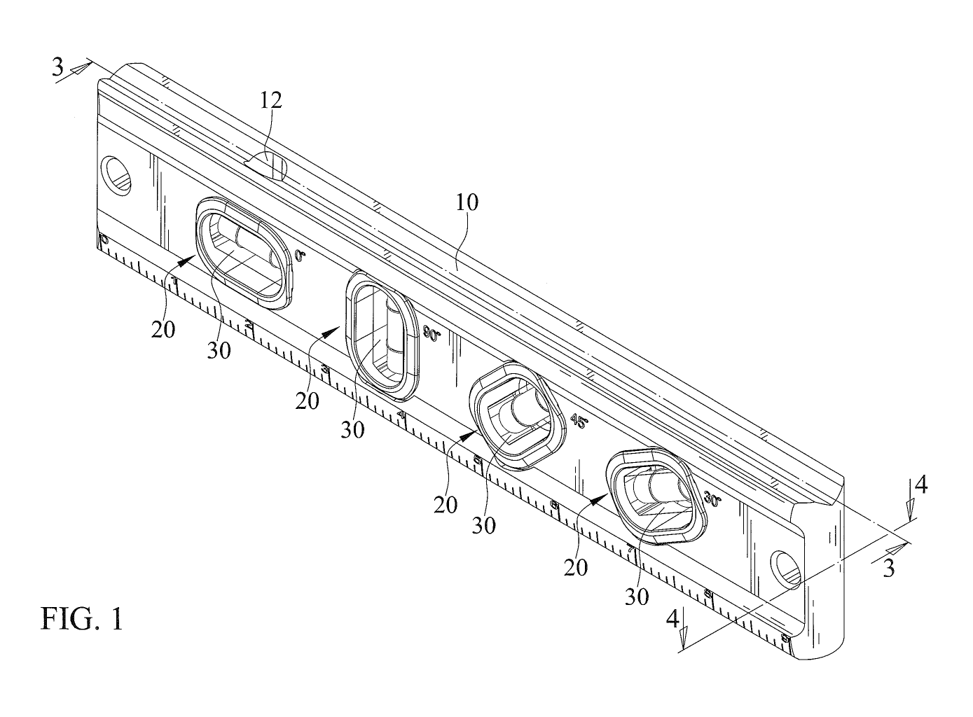

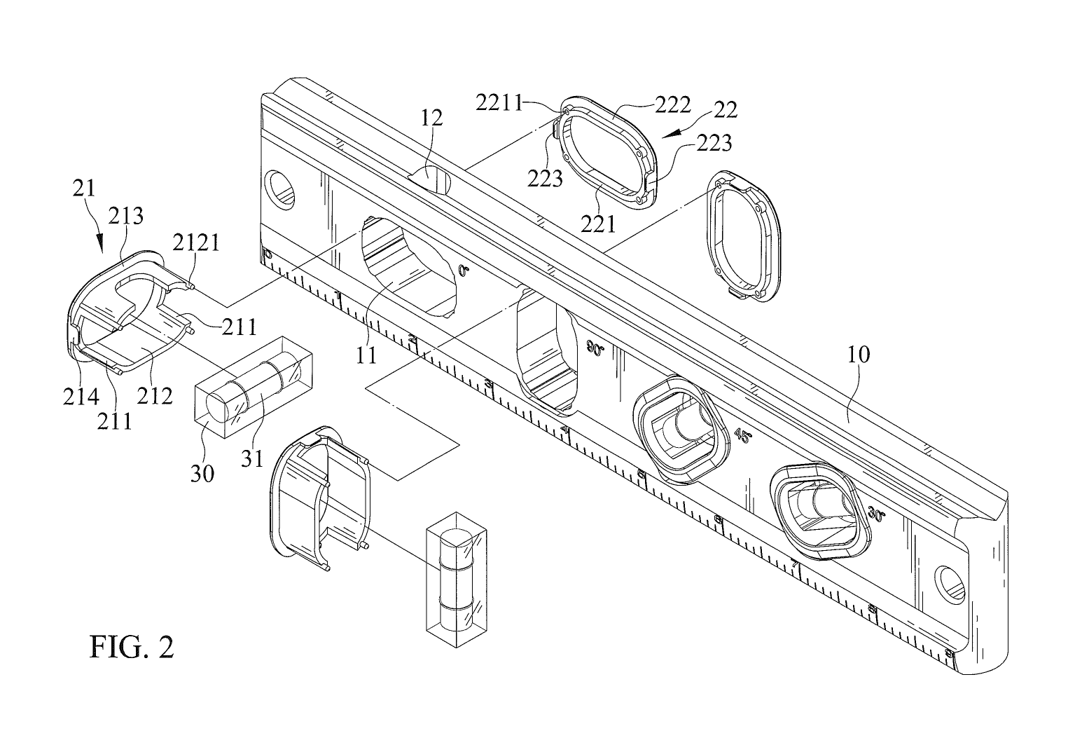

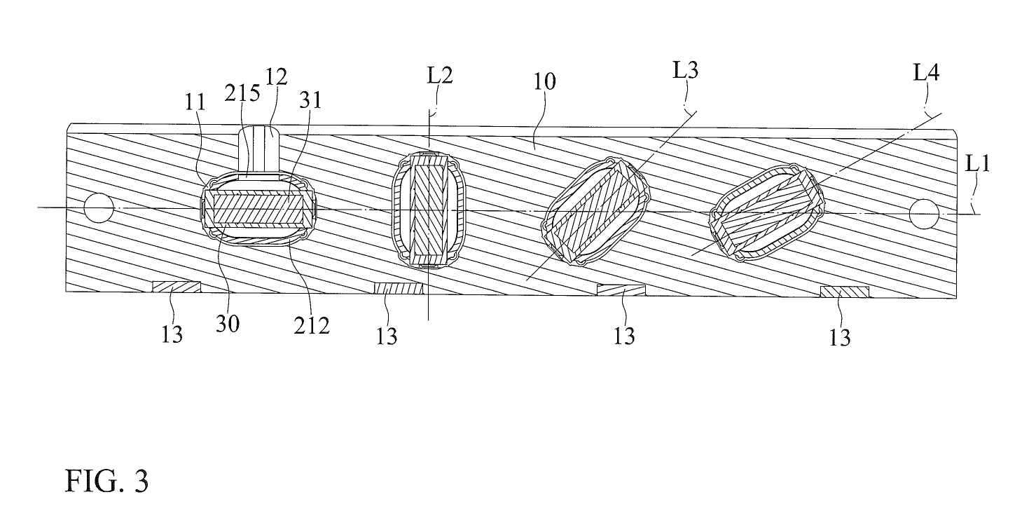

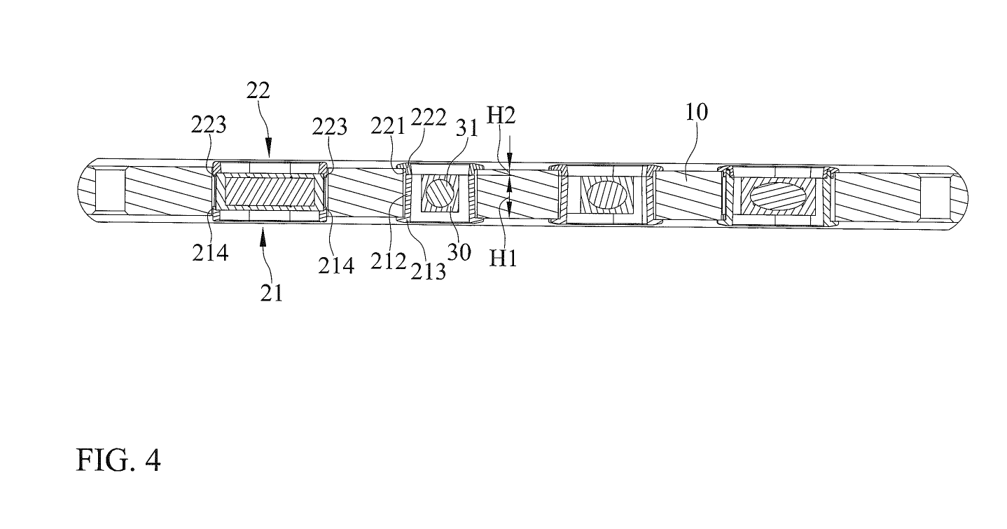

FIGS. 1 through 4 show an easy assembly level in accordance with the present invention. A body 10 defines at least one compartment 11. The at least one compartment 11 extends through the body 10. The at least one compartment 11 defines a first opening on a first side of the body 10 and a second opening on a second side of the body 10 respectively. The first and second sides of the body 10 define two opposite lateral sides of the body 10. The at least one compartment 11 extends through two lateral sides of the body 10. The at least one compartment 11 extends transversely to a length direction of the body 10. The body 10 defines a viewing aperture 12 extending therethrough. The viewing aperture 12 extends through a third side of the body 10 to the at least one compartment 11. The third side of the body 10 extends transversely between the first and second sides of the body 10.

The body 10 defines at least one recess. The at least one recess includes at least one magnet 13 received therein. The level can magnetically fix to a metal surface by the at least one magnet 13.

The body 10 is marked with units of measurement. The units of measurement are arranged along a length of the body 10.

At least one fixing assembly 20 includes a first retainer 21 and a second retainer 22. The first and second retainers 21 and 22 are releasably joinable to each other. The first and second retainers 21 and 22 are releasably mountable on the body 10.

The first retainer 21 defines a channel 211 and at least one bubble level vial 30 is received in the channel 211. The channel 211 defines two slots on the first wall 212. The two slots are diametrically opposite. The at least one bubble level vial 30 has a first end received by one of the two slots and a second end received by another of the two slots. The at least one bubble level vial 30 has an outer body of rectangular cross section and an inner body 31 of tubular cross section. The at least one bubble level vial 30 has a liquid held by the inner body 31. The outer and inner bodies are transparent. The at least one bubble level vial is incompletely filled with the liquid, thus leaving a bubble in the inner body. The bubble can be seen. The bubble naturally rests in the center of the inner body, and the bubble travels away from the marked center position at slight inclinations.

The first retainer 21 is inserted in the at least one compartment 11 through the first opening and is releasably mounted on the body 10. The second retainer 22 is inserted in the at least one compartment 11 through the second opening and is releasably mounted on the body 10. The first and second retainers 21 and 22 are releasably joined together and encapsulate the at least one bubble level vial 30 such that the at least one bubble level vial 30 is restrained by the first and second retainers 21 and 22 and is fixed to the body 10 and is disposed inside the at least one compartment 11.

The first retainer 21 defines a first connecting structure 2121 and the second retainer 22 defines a second connecting structure 2211 respectively. The first and second connecting structures 2121 and 2211 are complementary to each other. The first and second connecting structures 2121 and 2211 are releasably engagable with each other. One of the first and second connecting structures 2121 and 2211 defines at least one protrusion and another of first and second connecting structures 2121 and 2211 defines at least one hole. By engaging the first connecting structure 2121 with the second connecting structure 2211, the first and second retainers 21 and 22 are releasably joined together.

The first retainer 21 defines a first window and the second retainer 22 defines a second window respectively. The at least one bubble level vial 30 is visible from either the first window or the second window. The first window extends through the first retainer 21 and transversely to the length direction of the body 10. The second window extends through the second retainer 22 and transversely to the length direction of the body 10. The first and second windows face oppositely.

The first retainer 21 defines a first wall 212 extending annularly around the first window. The first wall 212 is received by the at least one compartment 11. The first wall 212 received by the at least one compartment 11 is of a first length H1. The second retainer 22 defines a second wall 221 extending annularly around the second window. The second wall 221 is received by the at least one compartment 11. The second wall 221 received by the at least one second compartment 11 is of a second length H2. The first length H1 is greater than the second length H2.

The first retainer 21 defines a first flange 213 extending radially outwardly from the first wall 212. The first side of the body 10 is abutted by the first flange 213. The first retainer 21 is inserted into the at least one compartment 11 until the first flange 213 abuts and is fit on the first side of the body 10. The second retainer 22 defines a second flange 222 extending radially outwardly from the second wall 221. The second side of the body 10 is abutted by the second flange 222. The second retainer 22 is inserted into the at least one compartment 11 until the second flange 222 abuts and is fit on the second side of the body 10.

The first retainer 21 defines two first stopping structures 214. One of the two first stopping structures 214 is located adjacent to one of the two slots defined by the channel 211 and another of the two first stopping structures 214 is located adjacent to another of the two slots respectively. One of the two first stopping structures 214 extends into one of the two slots defined by the channel 211 and abuts against the first end of the at least one bubble level vial 30 and another of the two first stopping structures 214 extends into another of the two slots and abuts against the second end of the at least one bubble level vial 30 respectively. The two first stopping structures 214 cooperate to releasably hold the at least one bubble level vial 30. The second retainer 22 defines two second stopping structures 223. One of the two second stopping structures 223 is located adjacent to one of the two first stopping structures 214 and another of the two second stopping structures 223 is located adjacent to another of the two first stopping structures 214 respectively. One of the two second stopping structures 223 abuts against the first end of the at least one bubble level vial 30 and another of the two second stopping structures 223 abuts against the second end of the at least one bubble level vial 30 respectively. The two second stopping structures 223 cooperate to releasably hold the at least one bubble level vial 30.

The first retainer 21 defines a cavity 215 extending therethrough. The cavity 215 extends through the first wall 212 of the first retainer 21. The cavity 215 are connected with and open to the at least one compartment 11 and the viewing aperture 12. Therefore, the at least one bubble level vial 30 received in the at least one compartment 11 can be seen from the viewing aperture 12.

The at least one bubble level vial 30 is oriented at 0 degree and extends longitudinally along a first axis L1. The body 10 extends longitudinally along the first axis L1.

The at least one compartment 11 includes a plurality of compartments 11. The at least one fixing assembly 20 includes a plurality of fixing assemblies, wherein the at least one bubble level vial 30 includes a plurality of bubble level vials 30. The plurality of bubble level vials 30 is oriented at different angles. The plurality of bubble level vials 30 includes one bubble level vial oriented at 90 degrees and extends longitudinally along a second axis L2, another bubble level vial 30 oriented at 45 degrees and extends longitudinally along a third axis L3, and another bubble level vial 30 oriented at 30 degrees and extends longitudinally along a forth axis L4, respectively. The second axis L2 is tilted perpendicular to the first axis L1. The third axis L3 is tilted at 45 degrees with respect to the first axis L1. The fourth axis L4 is titled at 30 degrees with respect to the first axis L1.

In view of the forgoing, the level is easy assembled. Furthermore, the first and second retainers 22 of the at least one fixing assembly 20 can be assembled without the aid of tools to hold the at least one bubble level vial 30. Moreover, the at least one fixing assembly 20 can be securely fit in the at least one compartment 11 of the body 10.

The foregoing is merely illustrative of the principles of this invention and various modifications can be made by those skilled in the art without departing from the scope and spirit of the invention.

What is claimed is:

1. An easy assembly level comprising:
a body defining at least one compartment, with the at least one compartment extending through the body, and with the at least one compartment defining a first opening on a first side of the body and a second opening on a second side of the body respectively;
at least one fixing assembly including a first retainer and a second retainer, with the first and second retainers releasably joinable to each other, and with the first and second retainers releasably mountable on the body;
at least one bubble level vial;
wherein the first retainer defines a channel and the at least one bubble level vial is received in the channel, wherein the first retainer is inserted in the at least one compartment through the first opening and is releasably mounted on the body, wherein the second retainer is inserted in the at least one compartment through the second opening and is releasably mounted on the body, wherein the first and second retainers are releasably joined together and encapsulate the at least one bubble level vial such that the at least one bubble level vial is restrained by the first and second retainers and is fixed to the body and is disposed inside the at least one compartment, wherein the first retainer defines a first window and the second retainer defines a second window respectively, and wherein the at least one bubble level vial 30 is visible from either the first window or the second window.

2. The easy assembly level as claimed in claim 1, wherein the first window extends through the first retainer and transversely to a length direction of the body, wherein the second window extends through the second retainer and transversely to the length direction of the body, and wherein the first and second windows face oppositely.

3. The easy assembly level as claimed in claim 1, wherein the first retainer defines a first wall extending annularly around the first window, wherein the first wall is received by the at least one compartment, and wherein the first wall received by the at least one compartment is of a first length.

4. The easy assembly level as claimed in claim 1, wherein the channel defines two slots on the first wall, wherein the two slots are diametrically opposite, and wherein the at least one bubble level vial has a first end received by one of the two slots and a second end received by another of the two slots.

5. The easy assembly level as claimed in claim 3, wherein the second retainer defines a second wall extending annularly around the second window, wherein the second wall is received by the at least one compartment, and wherein the second wall received by the at least one second compartment is of a second length.

6. The easy assembly level as claimed in claim 5, wherein the first length is greater than the second length.

7. The easy assembly level as claimed in claim 3, wherein the first retainer defines a first flange extending radially outwardly from the first wall, and wherein the first side of the body is abutted by the first flange.

8. The easy assembly level as claimed in claim 5, wherein the second retainer defines a second flange extending radially outwardly from the second wall, and wherein the second side of the body is abutted by the second flange.

9. The easy assembly level as claimed in claim 3, wherein the body defines a viewing aperture extending therethrough, wherein the viewing aperture extends through a third side of the body to the at least one compartment, wherein the third side of the body extends transversely between the first and second sides of the body, wherein the first retainer defines a cavity extending therethrough, wherein the cavity extends through the first wall of the first retainer, and wherein the cavity are connected with and open to the at least one compartment and the viewing aperture.

10. The easy assembly level as claimed in claim 1, wherein the first retainer defines a first connecting structure and the second retainer defines a second connecting structure respectively, wherein the first and second connecting structures are complementary to each other, and wherein the first and second connecting structures are releasably engagable with each other.

11. The easy assembly level as claimed in claim 10, wherein one of the first and second connecting structures defines at least one protrusion and another of first and second engaging structures defines at least one hole.

12. The easy assembly level as claimed in claim 1, wherein the at least one bubble level vial has an outer body of rectangular cross section and an inner body of tubular cross section, and wherein the at least one bubble level vial has a liquid held by the inner body.

13. The easy assembly level as claimed in claim 12, wherein the outer and inner bodies are transparent.

14. The easy assembly level as claimed in claim 4, wherein the first retainer defines two first stopping structures, wherein one of the two first stopping structures is located adjacent to one of the two slots and another of the two first stopping structures is located adjacent to another of the two slots respectively, and wherein one of the two first stopping structures extends into one of the two slots and abuts against the first end of the at least one bubble level vial and another of the two first stopping structures extends into another of the two slots and abuts against the second end of the at least one bubble level vial respectively.

15. The easy assembly level as claimed in claim 14, wherein the second retainer defines two second stopping structures, wherein one of the two second stopping structures is located adjacent to one of the two first stopping structures and another of the two second stopping structures is located adjacent to another of the two first stopping structures respectively, and wherein one of the two second stopping structures abuts against the first end of the at least one bubble level vial and another of the two second stopping structures abuts against the second end of the at least one bubble level vial respectively.

16. The easy assembly level as claimed in claim 9, wherein the at least one bubble level vial is oriented at 0 degree and extends longitudinally along a first axis, and wherein the body extends longitudinally along the first axis.

17. The easy assembly level as claimed in claim 1, wherein the at least one compartment includes a plurality of compartments, wherein the at least one fixing assembly includes a plurality of fixing assemblies, wherein the at least one bubble level vial includes a plurality of bubble level vials, and wherein the plurality of bubble level vials is oriented at different angles.

18. The easy assembly level as claimed in claim 1, wherein the body defines at least one recess, and wherein the at least one recess includes at least one magnet received therein.

19. The easy assembly level as claimed in claim 1, wherein the body is marked with units of measurement.

20. The easy assembly level as claimed in claim 19, wherein the units of measurement are arranged along a length of the body.
